(19) United States
(12) Patent Application Publication
(10) Pub. No.: US 2014/0081683 A1
(43) Pub. Date: Mar. 20, 2014

(54) BUSINESS PROCESS MANAGEMENT FOR MOBILE PORTAL CLIENTS

(71) Applicant: Nimrod Barak, Tel Aviv (IL)

(72) Inventor: Nimrod Barak, Tel Aviv (IL)

(73) Assignee: SAP AG, Walldorf (DE)

(21) Appl. No.: 13/620,361

(22) Filed: Sep. 14, 2012

(51) Int. Cl. G06Q 10/06

(52) U.S. Cl. 705/7.12

(57) ABSTRACT

The disclosure generally describes computer-implemented methods, software, and systems for integrating mobile portal client native application support into business processes. One computer-implemented method includes launching a business process, wherein the business process comprises a plurality of business process steps, monitoring, by operation of a computer, a back-end data environment for changes to data associated with the business process, transmitting, as part of a first business process step, business process data associated with the first business process step to a first application on a mobile client device, wherein the first application is a native application, and recording, by operation of a computer, indication data in the back-end data environment indicating, as part of a second business process step, that additional data associated with the transmitted business process data is to be displayed in a second application on the mobile client device.

### BACKGROUND

On modern mobile devices, interactions with a an enterprise portal application executing a modeled business process are primarily web-based, using, for example, a mobile client device's web browser to perform actions on and to consume content from the enterprise portal application. While mobile devices often contain native applications that may each provide a variety of useful functions that could enhance a user's experience with and/or provide normally non-web capable enterprise portal application functionality to the mobile device user, interaction with native applications is often limited due to their closed nature, security concerns, and/or inherent limitations due to operating system and technology differences. A modeled business process may require functionality that on a mobile client can only be provided by a combination of both web-based and native applications. The inability to execute such a modeled business process with the enterprise portal application on a mobile device, among other things, limits the usability of the enterprise portal application, inconveniences enterprise portal application users, and limits enterprise portal application developers to reduce otherwise available functionality when the enterprise portal application is executed on a mobile device platform.

### SUMMARY

The present disclosure relates to computer-implemented methods, software, and systems for integrating mobile portal client native application support into business processes. One computer-implemented method includes launching a business process, wherein the business process comprises a plurality of business process steps, monitoring, by operation of a computer, a back-end data environment for changes to data associated with the business process, transmitting, as part of a first business process step, business process data associated with the first business process step to a first application on a mobile client device, wherein the first application is a native application, and recording, by operation of a computer, indication data in the back-end data environment indicating, as part of a second business process step, that additional data associated with the transmitted business process data is to be displayed in a second application on the mobile client device.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features:

A first aspect, combinable with the general implementation, further comprising, based upon the recorded indication data, determining monitored back-end data changes associated with the business process.

A second aspect, combinable with any of the previous aspects, further comprising determining, from the determined monitored back-end data changes, the additional data to be displayed.

A third aspect, combinable with any of the previous aspects, further comprising displaying the determined additional data in the second application, wherein the second application is a native application.

In a fourth aspect, combinable with any of the previous aspects, wherein the second application interfaces with an application programming interface to receive the determined additional data.

In a fifth aspect, combinable with any of the previous aspects, wherein the first application interfaces with an application programming interface to transmit data identifying the additional data to the second application.

In a sixth aspect, combinable with any of the previous aspects, wherein the second application is a portal application.

In a seventh aspect, combinable with any of the previous aspects, wherein the second application interfaces with an application programming interface associated with the first application.

The subject matter described in this specification can be implemented in particular implementations so as to realize one or more of the following advantages. First, additional portal application capabilities for mobile portal clients are made available to portal application/business process developers due to the ability to integrate native applications of the mobile portal clients. The portal application/business process developers are able to build processes which are mobile platform agnostic and allow the portal application to choose appropriate applicable native applications, if any, to execute on a mobile portal client to accomplish one or more business process steps. For example, the portal may store metadata describing each general mobile portal client (e.g., IPHONE, ANDROID, smartphone, tablet, etc.) and more specifically particular metadata (e.g., native application name, description, uniform resource locator (URL), etc.) describing native applications associated with particular mobile portal clients (e.g., associated with a particular user, business entity, etc.). A portal application can then know in runtime which native applications are available on a particular mobile portal client and which native application is more appropriate to run if given a choice between two or more native applications on the particular mobile portal client. Second, a user's experience is enhanced and simplified by a tighter integration of native and web-applications. Users are able to execute the mobile portal application and have their actions automatically trigger supporting applications to display data and/or allow them to interact with the mobile portal application. Third, business process functionality can be enhanced due to the ability to include process steps which are based on both web technologies and native mobile applications. Developers can develop more consistent applications/business processes regardless of technology platform they execute on. Fourth, enhanced mobile portal client functionality may provide a marketing advantage for a particular portal application. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for integrating mobile portal client native application support into business processes.

FIG. 2 is a flow chart of an example modeled business process incorporating native applications.

FIG. 3 is a flow chart of an example method for incorporating native applications within a business process.

FIG. 4 is a flow chart of an example method for modeling a business process integrating native application support within the business processes.

Like reference numbers and designations in the various drawings indicate like elements.

### DETAILED DESCRIPTION

The disclosure generally describes computer-implemented methods, software, and systems for integrating mobile portal client native application support into business processes. For the purposes of this disclosure, an enterprise resource portal (ERP), also known as an enterprise information portal (EIP) or a corporate portal, is a framework for integrating information, people, and processes across organizational boundaries and offers a single point of access to information, enterprise applications, and services both inside and outside an organization. An ERP provides a secure unified access point, often in the form of a graphical user interface (GUI), such as a web browser, and is designed to aggregate and personalize information through application-specific portals. The ERP is a de-centralized content contribution and content management system, which keeps the information always updated. With the GUI, enterprise portal users can begin work once they have been authenticated in the ERP. ERPs may present information from diverse sources on mobile or other client devices in a unified and structured way, and provide additional services, such as dashboards, an internal search engine, e-mail, news, navigation tools, and various other features. ERPs are often used by enterprises for providing their employees, customers, and possibly additional users with a consistent look-and-feel, access control, and procedures for multiple applications, which otherwise would have been separate entities altogether.

On modern mobile devices, interactions with a an enterprise portal application executing a modeled business process are primarily web-based, using, for example, a mobile client device's web browser to perform actions on and to consume content from the enterprise portal application. While mobile devices often contain native applications that may each provide a variety of useful functions that could enhance a user's experience with and/or provide normally non-web capable enterprise portal application functionality to the mobile device user, interaction with native applications is often limited due to their closed nature, security concerns, and/or inherent limitations due to operating system and technology differences. A modeled business process may require functionality that on a mobile client can only be provided by a combination of both web-based and native applications. The inability to execute such a modeled business process with the enterprise portal application on a mobile device, among other things, limits the usability of the enterprise portal application, inconveniences enterprise portal application users, and limits enterprise portal application developers to reduce otherwise available functionality when the enterprise portal application is executed on a mobile device platform.

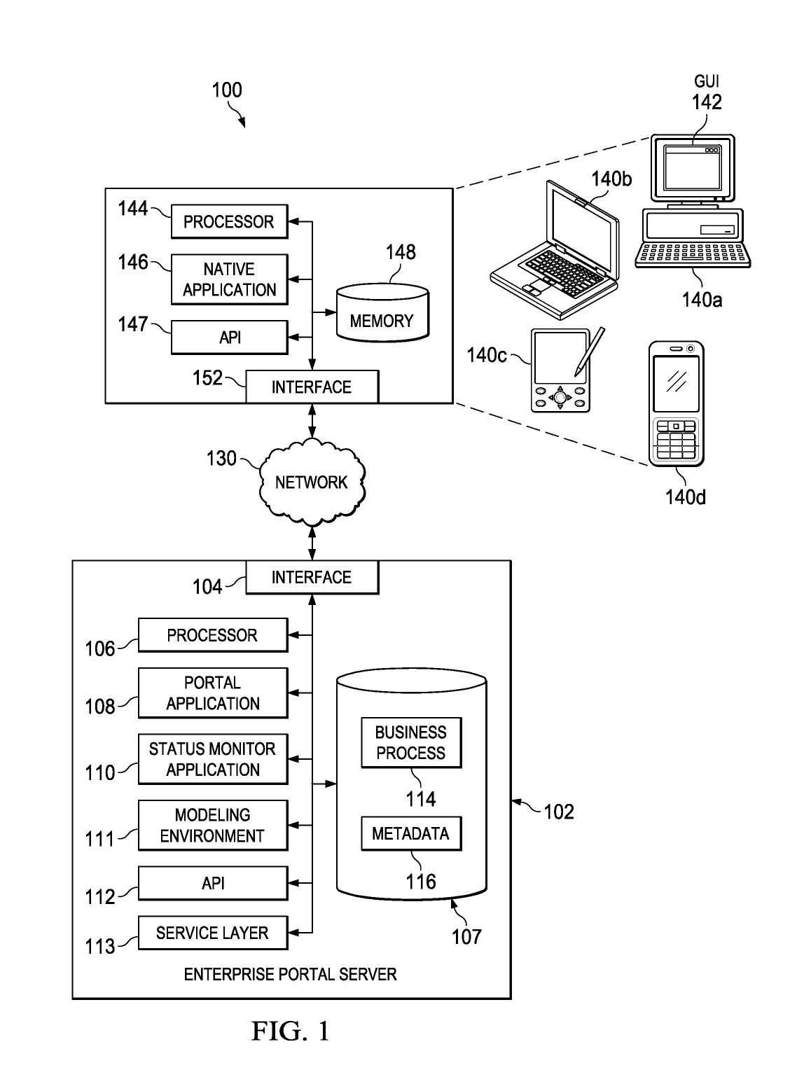

FIG. 1 is a block diagram illustrating an example distributed computing system 100 for integrating mobile portal client native application support into business processes. The illustrated example distributed computing system 100 includes or is communicably coupled with an enterprise portal server (EPS) 102 and a client 140 that communicate across a network 130.

At a high level, the EPS server 102 is an electronic computing device operable to receive, transmit, process, store, or manage data and information associated with the example distributed computing system 100. Generally, the EPS server 102 allows users to view, compose, modify, delete, and deploy enterprise portal pages. Specifically, the described computer-implemented methods, software, and systems provide functionality for integrating mobile portal client native application support into business processes within the example distributed computing system 100. According to one implementation, EPS 102 may also include or be communicably coupled with an e-mail server, a web server, a caching server, a streaming data server, and/or other suitable server.

The EPS 102 is responsible for receiving portal application requests, for example navigation and/or information requests, from one or more native applications 146 associated with the client 140, and responding to the received requests by processing said requests in the associated portal application 108 and sending the appropriate response from the portal application 108 back to the requesting native application 146. In addition to requests from the client 140, requests associated with the portal application 108 may also be sent from internal users, external or third-party customers, other automated applications, as well as any other appropriate entities, individuals, systems, or computers. The EPS 102 is also responsible for monitoring actions occurring on the EPS 102, the “back-end” of the example distributed computing environment 100. Actions may include, among others, data access, the setting of a flag or other data value, a push notification, etc.

The EPS 102 may contain a portal application 108, a status monitor application 109, and a modeling environment 110, where at least a portion of the portal application 108, the status monitor application 109, and/or the modeling environment 110 is executed using requests/responses sent from/to a client 140. In some implementations, requests/responses can be sent directly to EPS 102 from a user accessing EPS 102 directly. In some implementations, the EPS 102 may store a plurality of various portal applications 108, status monitor applications 109, and modeling environments 110. In some implementations, one or more of the components of EPS 102 can represent web-based applications accessed and executed by the client 140 using the network 130 or directly at the EPS 102 to perform the programmed tasks or operations of the various components of EPS 102.

In some implementations, any and/or all of components of the EPS 102, both hardware and/or software, may interface with each other and/or the interface using an application programming interface (API) 112 and/or a service layer 113. The API 112 may include specifications for routines, data structures, and object classes. The API 112 may be either computer language independent or dependent and refer to a complete interface, a single function, or even a set of APIs. The service layer 113 provides software services to the example distributed computing system 100. The functionality of the EPS 102 may be accessible for all service consumers using this service layer. Software services, such as provide reusable, defined business functionalities through a defined interface. For example, the interface may be software written in JAVA, C++, or other suitable language providing data in extensible markup language (XML) format or other suitable format.

While illustrated as an integrated component of the EPS 102 in the example distributed computing system 100, alternative implementations may illustrate the API 112 and/or service layer 113 as a stand-alone component in relation to other components of the example distributed computing system 100. Moreover, any or all parts of the API 112 and/or service layer 113 may be implemented as child or sub-modules of another software module, enterprise application, or hardware module without departing from the scope of this disclosure.

The EPS 102 includes an interface 104. Although illustrated as a single interface 104 in FIG. 1, two or more interfaces 104 may be used according to particular needs, desires, or particular implementations of the example distributed computing system 100. The interface 104 is used by the EPS 102 for communicating with other systems, for example the client 140, in the example distributed computing system using the network 130 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The EPS 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the EPS 102. Specifically, the processor 106 executes the functionality required to integrate mobile portal client native application support into business processes.

The EPS 102 also includes a memory 107 that holds data for the enterprise server 102. Although illustrated as a single memory 107 in FIG. 1, two or more memories may be used according to particular needs, desires, or particular implementations of the example distributed computing system 100. While memory 107 is illustrated as an integral component of the EPS 102, in alternative implementations, memory 107 can be external to the EPS 102 and/or the example distributed computing system 100. In some implementations, the memory 107, i.e., the content repository for the ERP 102 that holds the description and/or data for all objects, data, and/or business processes, such as one or more instances of business process 114.

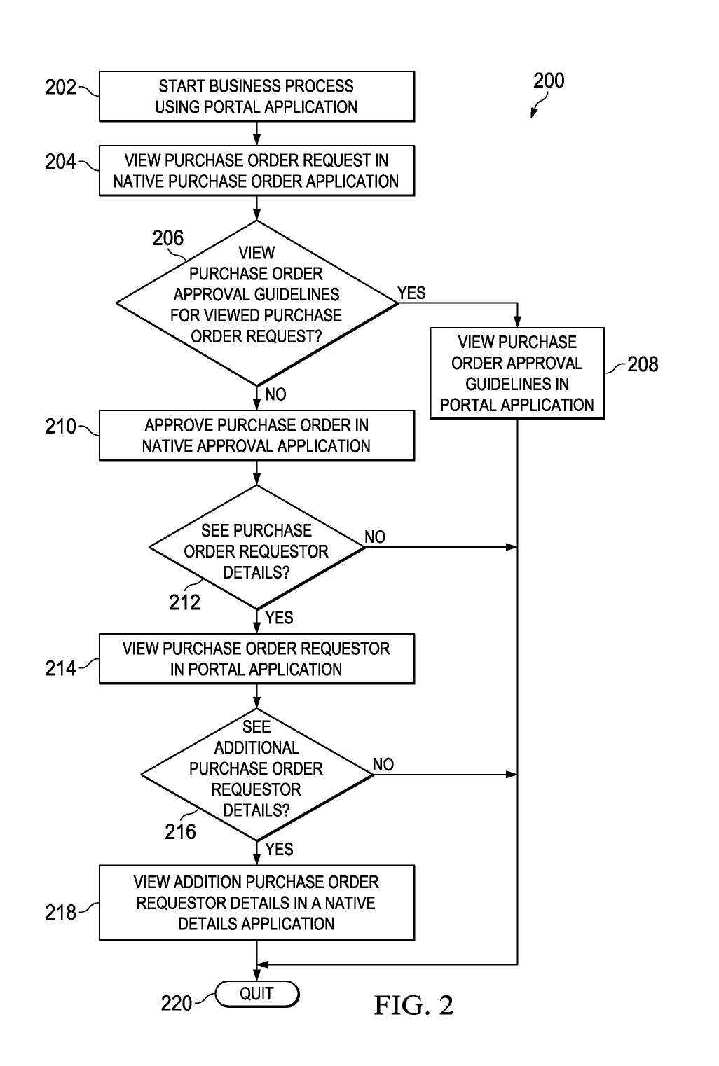

The business process 114 defines a set of related, structured activities, operations, or tasks that produce a specific service or product for a particular customer or customers, including services or products for the overall organization or elements of the organization performing the business process. In some implementations, business processes may be represented with a flowchart as a sequence of business process steps with interleaving decision points, such as that illustrated in FIG. 2. In other implementations, a business process can be represented in various other ways without departing from the scope of this disclosure. Each business process step of a business process model defines at least one business-related activity and is linked to at least one other process step in a defined business process model. In some implementations, a business process step can define applications necessary to and/or capable of performing the business process step for the business process as well as preferred applications, if available, and minimal application requirements for an application to perform the business process step.

The portal application 108 is generally a web-based application, but may also be any other type of application permitting a client 140 to request, view, edit, and/or delete content related to a particular business process 114 executing on the EPS 102. In some implementations, the portal application 108 is a web-based application deployed/hosted on a web server, such as EPS 102, and presented in a web browser.

In some implementations, the portal application 108 can be a service. In some implementations, the business process 114 is executed by the portal application 108 and/or the status monitor application 110, while in other implementations the business process 114 is executed in whole or in part by other component(s) (not illustrated) of either EPS 102 and/or the example distributed computing system 100. In some implementations, the portal application 108 provides web-based content associated with the business process 114 to one or more particular web-capable native applications 146. In some implementations, the portal application 108 can provide and/or instruct that web-based and/or non-web based content associated with the business process 114 is provided to a non-web-capable native application 146. For example, the portal application may instruct a web-browser-type first native application 146 executing on a client 140 to directly send data to a non-web-browser-type second native application 146 executing on the same client 140. In this instance, either the first and/or the second native application may be using or be integrally coupled with an API 147 (described below).

In some implementations, the portal application 108 can choose applicable native applications 146, if any, that are appropriate to execute on a client 140 to accomplish one or more business process 114 steps. For example, the EPS 102 may store metadata, such as metadata 116 describing each general client 140 type (e.g., IPHONE, ANDROID, smartphone, tablet, etc.) and, more specifically, particular metadata (e.g., native application name, description, uniform resource locator (URL), etc.) describing native applications 146 associated with particular clients 140 (e.g., devices associated with a particular user, business entity, etc.). The portal application 108 can then know in runtime which native applications 146 are available on a particular client 140 and which native application 146 is more appropriate to execute if given a choice between two or more native applications 146 on the particular client 140.

In some implementations, the portal application 108 is one in which all or some portion of the portal application 108 software is downloaded from a web, such as the Internet or local area network (LAN), each time it is run. The portal application 108 can usually be accessed from all web-capable mobile devices. As the portal application 108 is generally written in standardized, interoperable, “open” type languages, such as HTML 5, the portal application typically operates on multiple operating systems and hardware platforms, offers highly-flexible methods of interfacing with itself and other applications, such as the status monitor application 110, the modeling environment 110, the API 112, the service layer 113, and/or other components of the example distributed computing system 100.

In some implementations, the portal application 108 can work with the status monitor application 110 (described below) to synchronize and/or control the flow of the executing business process 114. In this implementation, the portal application 108 can delegate process flow control (described below) to the status monitor application 110.

A particular portal application 108 may operate in response to and in connection with at least one request received from other portal applications 108, including a portal application 108 associated with another EPS 102. In some implementations, each portal application 108 can represent a network-based application accessed and executed using the network 130 (e.g., through the Internet, or using at least one cloud-based service associated with the portal application 108). For example, a portion of a particular portal application 108 may be a web service associated with the portal application 108 that is remotely called, while another portion of the portal application 108 may be an interface object or agent bundled for processing at a remote client 140. Moreover, any or all of a particular portal application 108 may be a child or sub-module of another software module or enterprise application (not illustrated) without departing from the scope of this disclosure. Still further, portions of the particular portal application 108 may be executed or accessed by a user working directly at the EPS 102, as well as remotely at a corresponding client 140.

The status monitor application 109 is an application providing status monitoring the overall business process 114 and/or individual steps of the business process 114. In some implementations, the status monitor application 110 can be a service. In some implementations, the status monitor application 110 can be interfaced with directly by the portal application 108, a native application 146 and/or through API 112/service layer 113. In some implementations, the status monitor application 110 can monitor the back-end data storage of the EPS 102, for example a database, to determine whether a process step has been completed. In this example, the status monitor application may determine in the database that data has changed, a flag or other indicator has been set, a process has been started/terminated, and/or other suitable determination.

In some implementations, the status monitor application 110 can receive and response to queries from the portal application 108, the native application 146, and/or other components of the example distributed computing system 100. In some implementations, the status monitor application can in whole or in part control the flow of the business process 114, for example, the status monitor application can work in conjunction with the portal application 108 to determine when to proceed to the next step of business process 114, whether to query a user for data through the portal application 108 and/or the native application 146, whether to delay, start, terminate, and/or accelerate the business process 114.

A particular status monitor application 110 may operate in response to and in connection with at least one request received from another status monitor application 110, including a status monitor application 110 associated with another EPS 102. In some implementations, each status monitor application 110 can represent a network-based application accessed and executed using the network 130 (e.g., through the Internet, or using at least one cloud-based service associated with the status monitor application 110). For example, a portion of a particular status monitor application 110 may be a web service associated with the status monitor application 110 that is remotely called, while another portion of the status monitor application 110 may be an interface object or agent bundled for processing at a remote client 140. Moreover, any or all of a particular status monitor application 110 may be a child or sub-module of another software module or enterprise application (not illustrated) without departing from the scope of this disclosure. Still further, portions of the particular status monitor application 110 may be executed or accessed by a user working directly at the EPS 102, as well as remotely at a corresponding client 140.

The modeling environment 110 is a GUI tool that provides a portal application/business process developer the ability to visually display, select, adjust, and/or define a business process 114 by connecting one or more business process 114 components defining business process 114 steps along with defining data, transitions, condition extensions by code, and the like necessary to complete a particular/associated business process 114 step. In some implementations, the business process 114 components can be picked from a catalog of objects. The catalog of objects may contain, for example, applications from multiple technology types, web content, and pre-defined conditions. In some implementations, the conditions can be further customized. For example, if a decision is necessary in the business process 114, the decision may be selected along with the condition logic to perform the decision. Data necessary for the condition logic may also be specified as well an interface, method, and/or location to obtain and/or receive the necessary data. Business process 114 steps may also be defined to be performed by a portal application 108 and/or a native application 146. For example, if a business process 114 step is to be performed by either a particular portal application 108 and/or a native application 146 and the next business process 114 step is to be performed by the opposite type of application, in some implementations, transition criteria, a method of passing data between the business process steps, a method of obtaining and/or transmitting business process step status, and the like must defined in order for the portal application 108 and/or the native application 146 to properly process the business process 114 on the client 140.

The illustrated example distributed computing system 100 also includes a client 140. The client 140 may be any computing device operable to connect to or communicate with at least the EPS 102 using the network 130. In general, the client 140 comprises an electronic computer device operable to receive, transmit, process, and store any appropriate data associated with the example distributed computing system 100.

The illustrated client 140 includes a native application 146. The native application 146 is typically developed for a specific purpose, for a particular mobile device, such as a client 140, a particular operating system, for example IOS, ANDROID, or the like, and/or a particular mobile device firmware and typically needs to be adapted for each different type of mobile device it is executed on. For example, the native application may be a web browser application, a video gaming application, a calculator application, etc. In general, native applications are typically more “closed” in nature than a portal application (described below) and are consequently either prohibited and/or limited in their ability to be directly interfaced with, to integrate with other applications, to be customized, to have their status determined, etc. The closed aspect of native applications is often due to security concerns and/or inherent limitations of operating systems and hosting technology. However, in some instances, native applications 146 are permitted to receive parameters, such as URLs, documents to display, and/or other suitable parameter types and/or values.

In some implementations, the native application 146 may be a hybrid-type native application 146. For example, the native application 146 can be a native application container with little-to-no associated UI that allows the execution of HTML (e.g., a web browser such as SAFARI, CHROME, OPERA, BING, or other suitable web browser). This type of hybrid native application 146 permits the client 140 to interface with a remote web-based application. For example, in the case where the native application 146 is a web browser, the native application 146 can provide a client interface to permit a user to request, view, edit, and/or delete content within a web-based portal application 108 and/or a web-based modeling environment 111. In some instances, while the HTML can be executed within the native application 146 container, the container may still be restricted similar to as described above. In some instances, the HTML executed by the native application 146 can physically exist on the client 140 and/or the EPS 102.

The client 140 further includes an API 147. In some implementations, the API 147 provides enhanced functionality to a native application to permit communication with and/or from the native application not normally permitted by native applications. For example, a native application 146 may be modified to interface with an API to provide functionality permitting the native application 146 to be informed that a process step is waiting for data to be transmitted by the native application so that the native application is capable of displaying a pop-up dialog. In another example, the API 147 may permit data, for example parameters, data structures, status information, flags, etc. to be passed directly from a first native application to a second native application. In some implementations, the API 147 may be consistent with the above-mentioned API 112 but providing less or more functionality according to particular needs, desires, or particular implementations of the native application 147. In some implementations, the API 147 could be implemented as a stand-alone API or integral to the native application 147.

Further, the illustrated client 140 includes a GUI 142. The GUI 142 generates a visual representation of content generated by the portal application 108 in, for example, a native application 146. The GUI 142 also provides interactive functionally for a client 140 user to interface with a native application 146. For example, the GUI 142 may be used to view and/or navigate to/within various web pages, view, input, and/or delete data in a native application 146. In particular, the GUI 142 may be used to perform functions for interacting with a business process 114 executing on the ERP 102 through native applications 146 executing on a mobile portal client, such as client 140.

The illustrated client 140 further includes an interface, a processor, and a memory (not illustrated). The interface may be consistent with or different from the above-mentioned interface 104 of the ERP 102 and may be used by the client 140 for communicating with other computing systems in the example distributed computing environment 100 using the network 130. The processor may be consistent with or different from the above-described processor 106 of the ERP 102 and specifically executes instructions and manipulates data to perform the operations for the client 140, including the functionality required to send/receive requests/responses to/from the ERP 102. The memory may be consistent with or different from one or more of the above-described memories of the ERP 102 but storing objects and/or data associated with the purposes of the client 140.

There may be any number of clients 140 associated with, or external to, the example distributed computing system 100. For example, while the illustrated example distributed computing system 100 includes one client 140 communicably coupled to the EPS 102, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the EPS 102 on the client 140 itself, including digital data, visual information, audio information, and/or other suitable information.

Turning now to FIG. 2, FIG. 2 is a block diagram illustrating an example modeled business process 200 incorporating native applications. The business process 200 can be modeled by any suitable business process modeling tool, such as modeling tool 111, which permits the integration of native applications, such as native application 147, into the business process 200. This integration necessarily includes the specification of one or more of how client and native applications communicate with each other and/or other components of the example distributed computing system 100, indicate their status, receive and/or transmit data, are triggered and/or terminated, and other suitable criteria necessary to integrate native applications with business processes.

At 202, a business process begins execution through the use of a portal application on the EPS. In this example, the use of a portal application to start the business process is necessary because the business application must be triggered using the portal application. In other implementations, a native application can be designed to trigger the business process using an API call from either a native-application-integrated and/or separate API on the client and/or EPS. The API call can be made to one or more components of the EPS apart from the portal application. From 202, the business process 200 proceeds to 204.

At 204, a user wishes to open a native application to view requested purchase order data. For example, the user may be a purchasing manager and the native application may be used to present to the user current purchase order requests. Once open, the business process step 204 retrieves purchase order requests and displays them to the user. The user selects a particular purchase order request to view. From 204, the business process 200 proceeds to 206.

At 206, a determination is made whether the user wishes to view purchase order approval guidelines for the viewed purchase order request. If at 206, it is determined that viewing purchase order approval guidelines for the viewed purchase order request is desired, the business process 200 proceeds to 208. However, if at 206, it is determined that viewing purchase order approval guidelines for the viewed purchase order request is not desired, the business process 200 proceeds to 210.

At 208, a portal application must be launched because, in this example, the purchase order guidelines are only available through the portal application. However, this raises an issue. The native application used at 204 has no way to directly indicate to the portal application that needs to display specific purchase order guidelines information associated with the purchase order selected as well as useful associated information related to the selected purchase order, for example purchase order number, requestor, and other similar data.

There are two methods envisioned for addressing this issue. First, the portal application through the status monitor application, can attempt to determine information necessary to present the requested information to the user in the portal application. In some implementations, the status monitor application monitors all back-end transactions taking place between the native application and the back-end on ERP 102. For example, the status monitor application would be aware during its normal operation that a list of purchase order requests was served to the native application on a specific mobile device registered to a specific user. If the user selects in the native application to view purchase order approval guidelines, the native application cannot display them, but an indication selected in the native application can be used to set a flag on the ERP back-end. The status monitor application would be aware that a specific purchase order request was selected from the served purchase order request list and that a request was made to view purchase order guidelines because a data request was made by the native application to the ERP back-end to display specific information on the native application and a flag would be set on the ERP back-end indicating the desire to view purchase order approval guidelines. Using this information, the portal application can, without any further information from the native application, retrieve the proper purchasing order guidelines from the back-end system for the selected purchase order request as well as additional information associated with the selected purchase order request and present it to the user in the portal application.

Second, in some implementations, the native application can be integrated with an API, on the mobile client device and/or the ERP 102, to provide at least limited functionality to interface with the native application and to obtain data on actions performed for a business process within a native application. The integration with the API would permit functionality either to query the native application or for the native application to specifically transfer data to the portal application and/or other components of the example distributed computing system. For example, once the user has selected a specific purchase order and indicated in the native application to view purchase order guidelines for the selected purchase order, the integration with the API would permit the native application to either directly notify the portal application of the selected purchase order and indication to view associated purchase order guidelines and/or for the portal application to query the native application for the particular selected purchase order after receiving notice from the status monitor application once it detected that the user requested purchase order guidelines in the native application. After 208, the business process 200 stops at 220.

At 210, the user wishes to approve the selected purchase order. In this example, the purchase order must be approved in a different native application from the native application at 204. This again raises an issue. Typically native applications do not have the ability to directly communicate with each other. As described above in 208, similarly there are two options to address this issue. First, the status monitor application could be aware based on a flag or other indicator on the back-end that the user has selected to approve the purchase order in the native application of 204. The status monitor application or the status monitor application and the portal application could then retrieve information necessary to approve the selected purchase order and request the launch of a purchase order approval native application with parameters associated with the selected purchase order. In the launched purchase order approval native application, the user could then select to approve the purchase order. Second, an API could be integrated with the native application of 204 and/or the purchase order approval native application. The native application of 204 could send information related to the selected requested purchase order and an indication to approve the selected purchase order to either the purchase order approval native application API to launch it and/or the portal application/status monitor application to launch the purchase order approval native application. From 210, the business process 200 proceeds to 212.

At 212, a determination is made whether the user wishes to view purchase order requestor details. If at 212, it is determined that viewing purchase order requestor details is desired, business process flow proceeds to 214. However, if at 212, it is determined that viewing purchase order requestor details is not desired, the business process 200 stops at 220.

At 214, a portal application is launched to view purchase order requestor details. This is necessary because purchase order requestor details are only available to view through the portal application. Consistent with the description above, the example distributed computing system can use either the status monitor application to retrieve necessary information used to launch the portal application to view the selected purchase order requestor details or use an API to transfer information to the portal application, status monitor application, and/or other component of the example distributed computing system which is used to launch the portal application to view the selected purchase order requestor details. From 214, the business process 200 proceeds to 216.

At 216, a determination is made whether the user wishes to view additional purchase order requestor details. If at 216, it is determined that viewing additional purchase order requestor details is desired, business process 200 proceeds to 218. However, if at 216, it is determined that additional viewing purchase order requestor details is not desired, the business process 200 stops at 220.

At 218, the user wishes to view additional purchaser order requestor details. In this example, it is necessary to present the additional purchase order requestor details in a separate details native application. This is due, for example, because of security concerns and the desire to control access to this information to specific users and/or mobile client devices. Consistent with the above-mentioned description, the portal application can, in some implementations, either trigger the necessary details native application using parameters, for example a uniform resource locator (URL), purchase order request employee ID, and the like, or use the parameters with the portal application and/or the status monitor application to trigger the details native application to view the additional purchaser order requestor details. However, if the details native application will not accept parameters and/or allow the portal application to launch the details native application, the details native application can be integrated with an API to allow at least the portal application and/or the status monitor application to transfer necessary data and/or trigger the details native application to view the additional purchaser order requestor details. After 218, the business process 200 stops at 220.

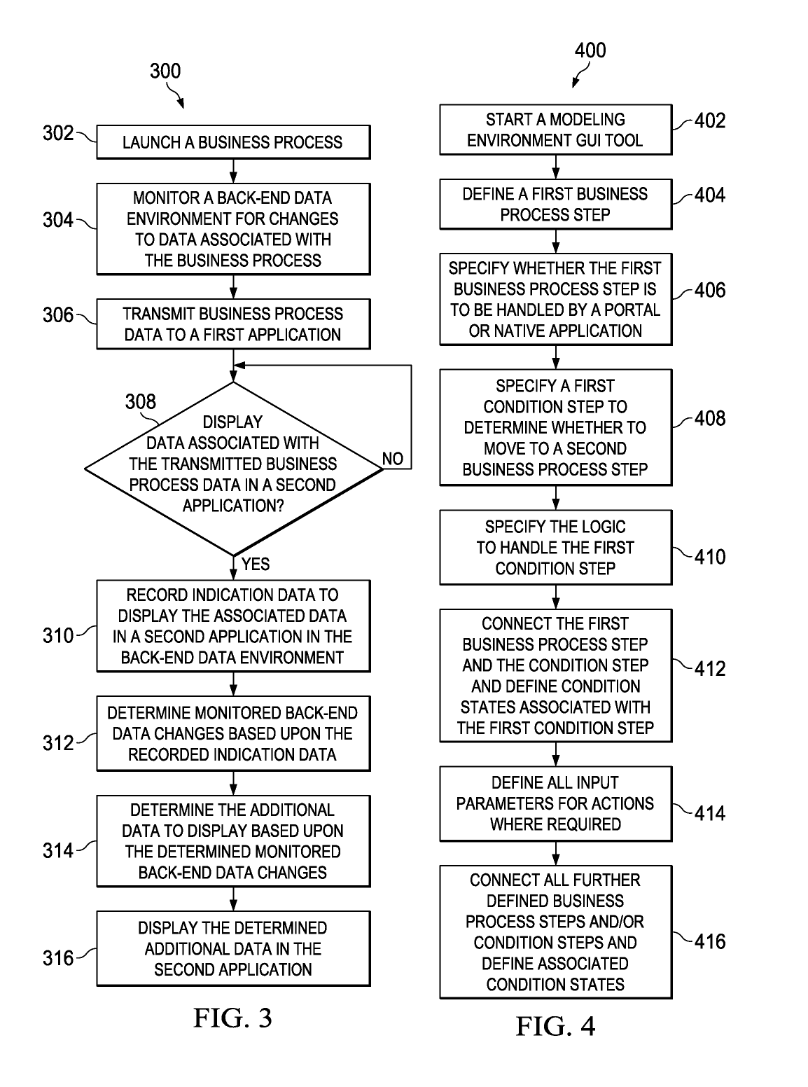

Turning now to FIG. 3, FIG. 3 is a flow chart of an example method for incorporating native applications within a business process. For clarity of presentation, the description that follows generally describes method 300 in the context of FIGS. 1 and 2. However, it will be understood that method 300 may be performed, for example, by any other suitable system, environment, software, and hardware, or a combination of systems, environments, software, and hardware as appropriate.

At 302, a business process is launched. In some implementations, the business process can be launched using a portal application to interface with a portal to launch the business process. In other implementations, the business process is launched using a native application installed on a client device to interface with the portal. In some implementations, the native application can use an integrated and/or stand-alone API to interface with the portal. From 302, method 300 proceeds to 304.

At 304, a back-end data environment on the portal is monitored for changes to data associated with the business process. For example, database table values specific to the business process may be monitored to determine when the values change. From 304, method 300 proceeds to 306.

At 306, business process data is transmitted to a first application. For example, web-based content may be transmitted to a hybrid native application for display on the client. From 306, method 300 proceeds to 308.

At 308, a determination is made whether data associated with the transmitted business process data is to be displayed in a second application. If at 308, it is determined that the data associated with the transmitted business process data is to be displayed in a second application, method 300 proceeds to 310. However, if at 308, it is determined that the data associated with the transmitted business process data is to be displayed in a second application, method 300 proceeds to 308. From 308, method 300 proceeds to 310.

At 310, indication data is recorded in the back-end data environment to indicate that data associated with the transmitted business process data is to be displayed in a second application. In some implementations, the indication data may be a flag, a data record, and/or other suitable indication data. From 310, method 300 proceeds to 312.

At 312, monitored back-end data environment data changes are determined based upon the recorded indication data. For example, if the indication data is associated with a purchase order, the portal may determine that purchase order data has been changed. From 312, method 300 proceeds to 314.

At 314, additional data, if any, to display in the second application is determined based upon the determined monitored back-end data environment changes. For example, if the indication data was associated with a particular client's purchase order, the business process may have logic to gather additional data associated with the particular client to display with the determined purchase order data. From 314, method 300 proceeds to 316.

At 316, the determined additional data is displayed in the second application. In some implementations, metadata associated with a particular client can specify available native applications, display formats, etc. associated with the particular client that can be used to most efficiently display the determined additional data. After 316, method 300 stops.

Turning now to FIG. 4, FIG. 4 is a flow chart of an example method 400 for modeling a business process integrating native application support within the business processes. For clarity of presentation, the description that follows generally describes method 400 in the context of FIGS. 1, 2, and 3. However, it will be understood that method 400 may be performed, for example, by any other suitable system, environment, software, and hardware, or a combination of systems, environments, software, and hardware as appropriate.

At 402, a modeling environment GUI tool is launched. In some implementations, a development “canvas”, that is a workspace environment, is provided on which to attach/model various business process components. As will be appreciated, the modeling environment may provide various types and/or formats of workspace environments, GUI tools, components, etc. without departing from the scope of this disclosure. From 402, method 400 proceeds to 404.

At 404, a first business process step is defined. The defined first business process step is placed on the provided workspace environment using the GUI tool. In some implementations, the business process step may be selected and/or dragged from a GUI catalog and/or manually defined and placed on the provided workspace environment. From 404, method 400 proceeds to 406.

At 406, the modeling tool is used to specify whether that first business process step is to be performed by a portal or native application. For example, this selection may be made using a check box, a pull down menu, or other suitable selection in the modeling environment GUI. From 406, method 400 proceeds to 408.

At 408, a first condition step is specified incorporating logic and condition states to determine whether to move to a second business process step. The modeling environment provides condition step types, for example, a return value condition, a JAVA function condition, a SQL query condition, another suitable condition step types. From 408, method 400 proceeds to 410.

At 410, logic associated with the specified first condition step is specified. For example, the logic may include software code to analyze output parameters from a prior business process step, receive a web-service call, a function/method to check a data value, and other suitable logic. From 410, method 400 proceeds to 412.

At 412, at least the first business process step and the first condition step are connected. Condition states associated with the first condition step are also defined and are used to determine the next business process step to be executed. For example, a condition state can determined by the specified logic, for example a JAVA function. In this example, the specified logic can call the backend data environment to check a particular data value and, responsive to the checked particular value and the condition logic, direct the business process to execute a particular step using either a native or portal application. As a further example, if a manager executing a business process for approving vacation requests has approved a vacation greater than X days in length for a particular employee, the condition state can indicate that the manager should be directed to adjusted guidelines concerning extended vacations using a portal application. If the vacation is X days or less, the condition state can indicate that the manager should be directed to a portal application providing additional possible actions to perform related to the particular employee. From 412, method 400 proceeds to 414.

At 414, input parameters for required actions are defined. Input parameters are properties that can be passed to an application, for example a customer identification number, in order to provide context within one or more applications, either native or web-based portal. The use of input parameters allows the business process to appear more cohesive and coherent regardless of the use of various application types. From 414, method 400 proceeds to 416.

At 416, all further defined business process steps and/or condition steps are connected and associated condition states are defined consistent with the explanation above. After 416, method 400 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
launching a business process, wherein the business process comprises a plurality of business process steps;
monitoring, by operation of a computer, a back-end data environment for changes to data associated with the business process;
transmitting, as part of a first business process step, business process data associated with the first business process step to a first application on a mobile client device, wherein the first application is a native application; and
recording, by operation of a computer, indication data in the back-end data environment indicating, as part of a second business process step, that additional data associated with the transmitted business process data is to be displayed in a second application on the mobile client device.

2. The computer-implemented method of claim 1, further comprising, based upon the recorded indication data, determining monitored back-end data changes associated with the business process.

3. The computer implemented method of claim 2, further comprising determining, from the determined monitored back-end data changes, the additional data to be displayed.

4. The computer-implemented method of claim 3, further comprising displaying the determined additional data in the second application, wherein the second application is a native application.

5. The computer-implemented method of claim 4, wherein the second application interfaces with an application programming interface to receive the determined additional data.

6. The computer-implemented method of claim 1, wherein the first application interfaces with an application programming interface to transmit data identifying the additional data to the second application.

7. The computer-implemented method of claim 3, wherein the second application is a portal application.

8. The computer-implemented method of claim 7, wherein the second application interfaces with an application programming interface associated with the first application.

9. A non-transitory, computer-readable medium storing computer instructions executable by a data processing apparatus to perform operations comprising:
launching a business process, wherein the business process comprises a plurality of business process steps;
monitoring a back-end data environment for changes to data associated with the business process;
transmitting, as part of a first business process step, business process data associated with the first business process step to a first application on a mobile client device, wherein the first application is a native application; and
recording indication data in the back-end data environment indicating, as part of a second business process step, that additional data associated with the transmitted business process data is to be displayed in a second application on the mobile client device.

10. The computer-readable medium of claim 9, further comprising instructions to perform, based upon the recorded indication data, determining monitored back-end data changes associated with the business process.

11. The computer-readable medium of claim 10, further comprising instructions to perform determining, from the determined monitored back-end data changes, the additional data to be displayed.

12. The computer-readable medium of claim 11, further comprising instructions to perform displaying the determined additional data in the second application, wherein the second application is a native application.

13. The computer-readable medium of claim 12, wherein the second application interfaces with an application programming interface to receive the determined additional data.

14. The computer-readable medium of claim 9, wherein the first application interfaces with an application programming interface to transmit data identifying the additional data to the second application.

15. The computer-readable medium of claim 11, wherein the second application is a portal application.

16. The computer-readable medium of claim 15, wherein the second application interfaces with an application programming interface associated with the first application.

17. A system, comprising:
memory operable to store a business process; and
at least one hardware processor interoperably coupled to the memory and operable to:
launch a business process, wherein the business process comprises a plurality of business process steps;
monitor a back-end data environment for changes to data associated with the business process;
transmit, as part of a first business process step, business process data associated with the first business process step to a first application on a mobile client device, wherein the first application is a native application; and
record indication data in the back-end data environment indicating, as part of a second business process step, that additional data associated with the transmitted business process data is to be displayed in a second application on the mobile client device.

18. The system of claim 17, further operable to perform, based upon the recorded indication data, determining monitored back-end data changes associated with the business process.

19. The system of claim 18, further operable to perform determining, from the determined monitored back-end data changes, the additional data to be displayed.

20. The system of claim 19, further operable to perform displaying the determined additional data in the second application, wherein the second application is a native application.

21. The system of claim 20, wherein the second application interfaces with an application programming interface to receive the determined additional data.

22. The system of claim 17, wherein the first application interfaces with an application programming interface to transmit data identifying the additional data to the second application.

23. The system of claim 19, wherein the second application is a portal application.

24. The system of claim 23, wherein the second application interfaces with an application programming interface associated with the first application.
